(19) United States
(12) Patent Application Publication
(10) Pub. No.: US 2006/0208081 A1
(43) Pub. Date: Sep. 21, 2006

(54) Methods of recording and reading digital data on a photographic support

(75) Inventor: Thierry Prigent, Saint-Helene (FR)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 11/375,962

(22) Filed: Mar. 15, 2006

(30) Foreign Application Priority Data
Mar. 18, 2005 (FR) 0502672

(51) Int. Cl. G06K 7/10

(52) U.S. Cl. 235/454

(57) ABSTRACT

The invention relates to a method of recording of digital data on a photographic support, comprising the conversion of the data into color and/or density values and the writing, for each data item, of at least one writing range, whose color and/or density correspond to the data, characterized in the fact that the ranges are arranged in a plurality of uniform blocks of writing ranges uniformly covering a writing zone of the photographic support, the blocks each being formed of at least one writing range and being associated with at least one position mark fixed to the support respectively.

### CROSS REFERENCE TO RELATED APPLICATION

Reference is made to and priority claimed from French Application Ser. No. 0502672 filed Mar. 18, 2005.

### FIELD OF THE INVENTION

The present invention relates to a method of recording and reading digital data on a photographic support. It also relates to the support necessary to implement the methods. The invention aims to facilitate the reproduction of recorded digital data and prevent their incorrect reading. This is especially a question of avoiding an incorrect reading liable to occur because of a mismatch between a reading device and the data ranges recorded on the support. The invention also aims to prevent reading errors due to a distortion of the support. It has applications in the field of data conservation, and in particular the long storage of photographic data.

### BACKGROUND OF THE INVENTION

Apart from their common use of recording analog images, in particular photos, photographic supports can also be of use in recording digital data. The digital data are first converted into color values and/or optical density values. Then a range of the photographic support whose color and/or density correspond in a one-to-one way to the value of the data is associated with each data item to be recorded. Such a method is described, for example, in reference FR 0312627, which corresponds to WO 2005/048177.

FIG. 1 shows a recording support 10 with a plurality of writing ranges 12 laid out according to a matrix. Although it is not inevitably the case, especially because of a possible attenuation at the edges of the ranges produced in the writing, it is assumed, for simplification, that each range 12 has uniform color and density. Thus, when the support is read, it is possible to analyze the density and/or color of each range and reconvert it to the digital value. This is possible especially thanks to the one-to-one relationship existing between the colors and densities on the one hand and the digital values on the other hand. On FIG. 1, the reference 14a designates a reading zone of the support 10. This corresponds, for example, to a zone viewed by a semiconductor sensor or by a flying reading spot. The reading zone 14a is located on a range 12. It enables the uniform color or density of the range to be read. Moreover it is centered on the range, which enables any inhomogeneities of the range edge to be ignored. The reading performed in the centered reading zone thus enables the value contained by the range to be restored reliably.

Another reading zone 14b is offset in relation to the frame of the writing ranges. It is partially overlapped with four writing ranges. Thus a reading signal delivered by the reading device during the reading of the offset zone 14b accounts for none of the density or color values of the overlapped ranges. The delivered signal corresponds to a sort of average weighted by the overlap area of each range and thus essentially depends on the position of the reading zone 14b. Except for the very special case where the four partially overlapping ranges have exactly the same color and density values, the digital value calculated from the reading signal does not reflect the value of the recorded data. The reading is thus incorrect.

When the resolution of the reading equipment is high, i.e. if the reading zones 14c are small compared with the writing ranges, the risk of an incorrect reading due to an offset can be reduced. However, it is not eliminated. This is illustrated by the reading zones 14c, 14d and 14e of FIG. 1. The reading zones 14c and 14d enable faithful reproduction of the recorded data. The reading zone 14e produces an incorrect reproduction.

The errors due to the offsets can result from poor adjustment or blocking of the reading instrument, especially when the reading zone has a size comparable to the writing ranges. They can also result from distortion of the photographic support.

### SUMMARY OF THE INVENTION

The object of the invention is to propose a writing and reading method, as well as a support for the storage of digital data, not having the above-mentioned difficulties.

One object is in particular to prevent an incorrect reading because of an inadequacy of the reading zones and writing ranges.

One object is also to improve the exactness of the reading for supports having been distorted, or at least locally distorted.

Finally, one object is to propose a support and writing and reading methods enabling long-term data storage, so as to overcome any obsolescence of the reading equipment.

To achieve these objects, the invention has more precisely for object a method of recording digital data on a photographic support comprising the conversion of the data into color and/or density values and the writing, for each data item, of at least one writing range whose color and/or density correspond to the data item. According to the invention, the ranges are arranged in a plurality of homogeneous blocks of writing ranges uniformly covering a writing zone of the photographic support, each block being formed of at least one writing range and being respectively associated with at least one position mark fixed to the support.

Photographic support means any type of support enabling the recording of colors or densities. This is for example a photosensitive support, such as photographic film or paper, or again a support for inkjet printing, or thermal or other printing.

The term “block” here means a compact set of writing ranges but does not foresee the shape of the block or ranges.

The blocks, as well as the ranges are preferably square. Other shapes, such as rectangles, circles, triangles or hexagons are nevertheless possible. In general, the ranges and blocks preferably have a shape and arrangement enabling the optimized coverage of a writing zone of the photographic support, by avoiding unused zones.

The position mark associated with each block is for local marking that enables the block to be located and thus the ranges forming the block. This mark is useful during the reading to extract the digital data of measurements made in the ranges of the blocks and, preferably, in the center of the ranges. The localization of the ranges is all the more accurate as the number of writing ranges per block is low and thus the number of marks is high. Although each writing range can be associated with a mark, which amounts to providing blocks with a single writing range, the blocks preferably contain from 4 to 64 ranges.

The position marks can be imprints, bosses or perforations made in or on the support. As photographic supports are generally read by optical means, the position marks are preferably marks that are also optically legible. The bosses and imprints can be read optically by using their properties of light interference or diffraction, for example. Other reading possibilities are described below.

In a particular implementation of the recording process, the position mark includes a border of more or less uniform color and/or density, adjacent to each block respectively, separating at least one side of the block and at least one neighboring block.

Preferably, when the blocks are square or rectangular, the border is arranged on two adjacent sides of each block.

The position marks can be formed directly when the ranges are written. This is, for example, an unexposed zone of the support, or a zone exposed with set energy and color. The position marks are not necessarily uniform, but have sufficient contrast in relation to the ranges to be read. The marks can also be formed by inkjet. For example, a photosensitive support can receive range writing by exposure of the support, and writing of the position marks by inkjet.

The mark is, for example, an opaque black border.

The position marks can again be comprised of local non-photosensitive zones of a photosensitive support outside these zones.

According to another implementation possibility, position marks can be used that comprise magnetic particles, such as, for example, ferromagnetic or ferrimagnetic particles. Again position marks can be used that comprise a fluorescent substance, capable of being excited at the time of reading.

The magnetic and/or fluorescent particles can be dispersed in an ink used to write the marks on the support using an inkjet device. In this case, the position mark comprises magnetic particles or a fluorescent substance arranged on the surface of the support.

The magnetic particles or fluorescent substance can also be arranged in the substrate or embedded in the substrate. This can be achieved by covering in a multilayer support, or by implanting particles in the support.

It should be noted that the data writing method can be implemented either with a substrate free of position marks or with a substrate already having the marks before its use for data recording. In the first case, the position marks can be formed concomitantly with the writing ranges, or immediately before or after range forming, in the same device. In the second case, the writing ranges have to be written in alignment with the pre-existent marks.

In one implementation of the method for image data conservation, it is also possible to provide data coding that more or less keeps the colors of the image. It is also possible to arrange the blocks and writing ranges so as to reproduce the iconic content of the image. The reproduction, even approximately, of the iconic content, i.e. the main forms of the image, enables quick awareness, and without specific reading tool, of the type of recorded data. These measures are useful for long-term image conservation, i.e. for which the existence of suitable reading tools is in itself a conservation unknown. Visual recognition of the images greatly facilitates their classification and restoration.

The invention also relates to a photographic support achieved at the end of the method and bearing a plurality of writing ranges, the ranges being arranged in blocks covering a writing surface more or less uniformly, and blocks being associated with position marks. The marks can have one of the above-mentioned shapes.

The invention also relates to a method for reading such a support.

The Method Comprises:

the reading of the photographic support to supply a digital image and a distribution pattern of the writing ranges in each block, and
the selection of reading data corresponding to the location of the writing ranges of each block.

Digital image means a set of data resulting from the reading of color and/or density values and the conversion of these values into digital data. The digital image can have iconic content, especially if the data relate to a photograph.

However, this is not Necessary.

In the particular implementation of the method, the selection of the location of the writing ranges can comprise:
the establishment of a pseudo-period of repetition of the position marks
the generation of a kernel corresponding to the pseudo-period
the calculation of a function of inter-correlation of the digital image and the kernel to determine the maxima location of the inter-correlation function
the selection of data of the digital image, corresponding to the maxima and coinciding with the distribution pattern of the writing ranges.

The distribution of the writing ranges in the blocks can be found by visual examination of the support, possibly using a magnifying glass. This data can also be indicated or printed legibly on the support. The support can also comprise information about the coding of the data in color or density values to facilitate the restoration of the digital data. The support can also comprise a sensitometric control capable of demonstrating or correcting the effects of ageing of the support, especially altering its colors.

According to the type of position marks present on the support, several possibilities are available to establish the pseudo-period of the position marks.

The pseudo-period can occur by direct optical reading of the marks. For example, this is Kerr effect reading when the marks have magnetic particles. In this case, reading using a magnetic head is also possible.

The pseudo-period can be also established by an auto-correlation calculation performed on the digital image.

Other characteristics and advantages of the invention will appear in the following description, with reference to the figures of the appended drawings. This description is given purely as an illustration and is not limiting.

### BRIEF DESCRIPTION OF THE DRAWINGS

FIG. 1, previously described, shows a photographic recording support and illustrates known techniques for recording and reading digital data;

FIG. 2 shows a recording support resulting from a recording according to the invention;

FIG. 3 is a schematic cross-section of a support according to the invention and illustrates a possible embodiment of the position marks;

FIG. 4 is a schematic cross-section of a support according to the invention and illustrates an another possible embodiment of the position marks;

FIG. 5 is a graph showing the reading signals of a support according to the invention, for a first color component, in this case red;

FIG. 6 is a graph showing the reading signals of a support according to the invention, for a second color component, in this case green;

FIG. 7 is a graph showing the reading signals of a support according to the invention, for a third color component, in this case blue;

FIG. 8 shows a processing step of the FIG. 5 signals;

FIG. 9 shows a processing step of the FIG. 6 signals;

FIG. 10 shows a processing step of the FIG. 7 signals;

FIG. 11 shows a next processing step of the FIG. 5 signals;

FIG. 12 shows a next processing step of the FIG. 6 signals;

FIG. 13 shows a next processing step of the FIG. 7 signals; and

FIG. 14 illustrates schematically a Kerr effect reading device of magnetic marks.

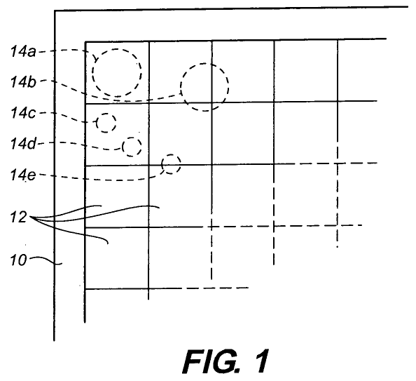

### DETAILED DESCRIPTION OF THE INVENTION

For simplification purposes, identical, similar or equivalent parts of the various figures are marked with the same reference signs. Furthermore, the figures are shown not to scale.

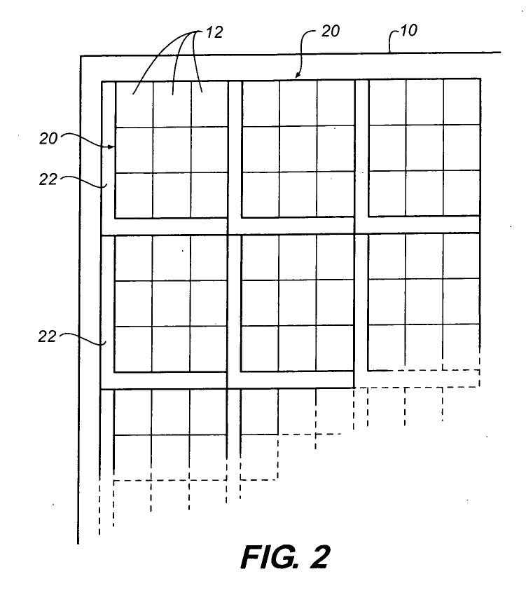

FIG. 2 shows a photographic support 10, for example a sheet of printed paper, or photosensitive film, having digital data recorded according to the invention. Rectangular writing ranges 12 correspond respectively to digital data coded in terms of color and/or density. More precisely, each range has a color and/or density that are one-to-one functions of the digital value it represents.

Possibly, a digital value can be coded not in one, but in a set of several ranges, with a one-to-one relationship between the value and the densities and/or colors of the set of ranges.

The ranges are arranged in a plurality of blocks 20. The blocks, all identical, each comprise a set of nine ranges juxtaposed according to a pattern of 3×3 rectangles. Other patterns, such as 3×4, 4×4, 5×5 etc., and other shapes of ranges and blocks can be selected.

Each block is associated with a position mark 22. In the case of FIG. 2, this is a border arranged along two adjacent sides of each block 20. Taken in the direction of the figure, this is the left side and bottom side. The border is a zone in which the photographic support is separated from the writing ranges. As mentioned above, the border of each block can be a zone that is exposed or printed more or less uniformly and more or less identically for each block. It can also be an unexposed zone of the support, or even a non-sensitive zone of the support.

Each position mark constitutes a local mark. By knowing the distribution pattern of the ranges in each block, it is possible, thanks to the marks, to determine locally, but with high precision, the location of the ranges, and, possibly, the location of the center of the ranges. The possibility of locally determining the location of the ranges enables reading offsets due to distortions of the support to be prevented.

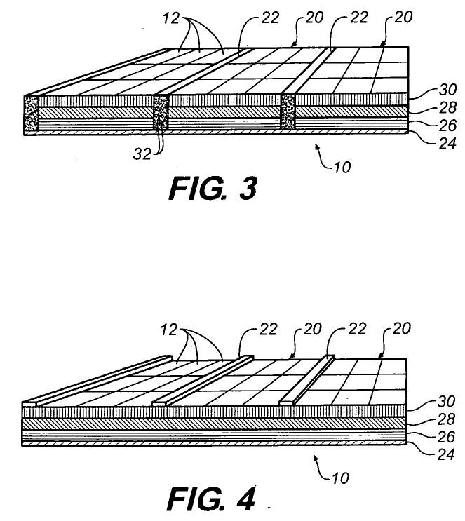

FIG. 3 is a partial schematic cross-section of a photographic support 10 according to the invention. It shows in particular a film with three photosensitive layers 26, 28, 30 formed on a support layer 24. The three layers are, for example, sensitive to red, green and blue, or cyan, magenta and yellow.

The position marks 22 are zones of the support 10, photosensitive or not, in which the magnetic metal particles 32 are implanted. These are, for example particles of Fe, FeCo, CrO₂, whose dimensions are between 0.01 μm and 10 μm, and preferably between 0.1 μm and 1 μm.

Another implementation is illustrated in cross-section by FIG. 4. In this case, the position marks 22 are ink strips formed on the surface of the support 10. The ink used to form the strips can possibly contain magnetic particles. It can more simply be an opaque ink, whose density is preferably higher than 3.

When reading a support such as described, a first step consists in scanning the support. This can take place in a known way using a bar, matrix, or flying spot scanner. The scanner produces a signal, and preferably a digital signal, representative of the densities and colors of the read support. This is the digital image.

The signal is first used to determine the location of the writing ranges and then to extract the recorded data from it.

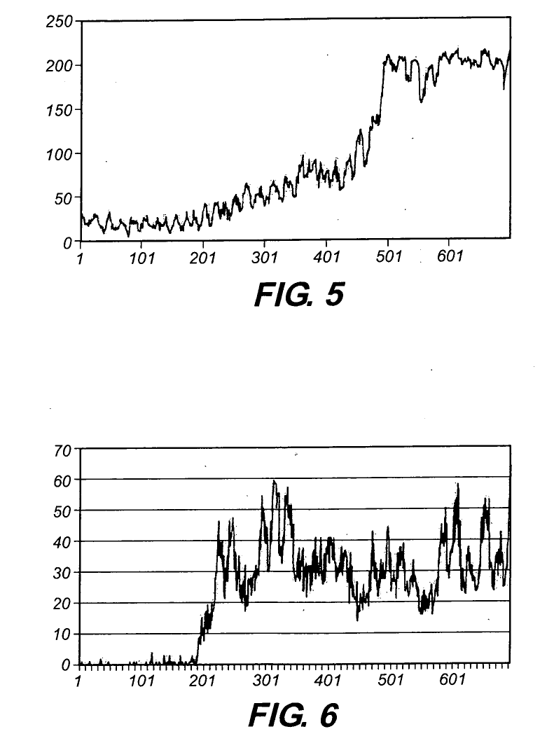

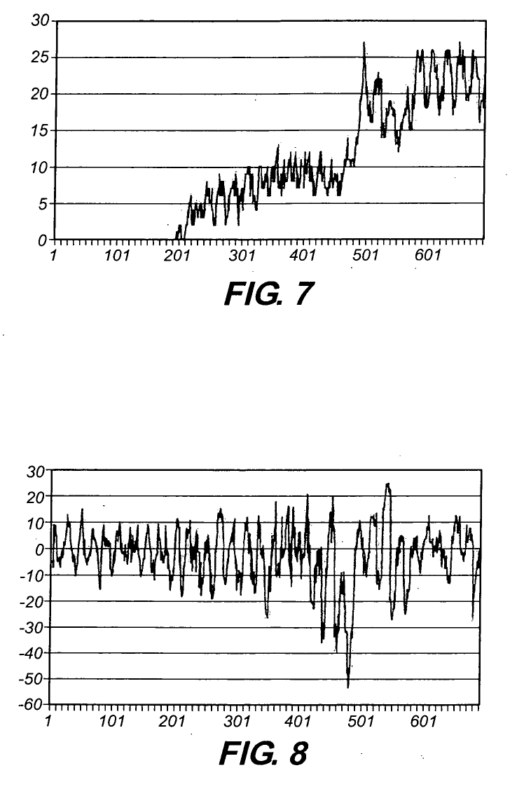

FIGS. 5, 6 and 7 show, in graph form, a reading row from the scanner formed by a plurality of reading points or pixels. It should be noted that the reading rows do not necessarily correspond to a row of ranges of the photographic support read. The row is relative to the reading device. It can be the row of a matrix sensor or a step of advancement of a reading bar or again the frame row of a reading spot. All the reading rows, i.e. the set of digital values constituting “the digital image”.

The graphs of FIGS. 5, 6 and 7 represent more precisely an extract of the reading signals of the red, green and blue components respectively of the row. The abscissa gives the numbers of pixels and the ordinate an amplitude proportional to the support's density. The pixels given on the abscissa are reading pixels whose dimension is fixed by the spatial frequency of sampling of the reading scanner. Thus these have no relation with the support's ranges. Following Shannon's law, the sampling frequency is preferably selected as large compared with an assessed size of the writing ranges. To establish the location of the writing ranges, the position marks are identified.

Thus, having scanned the photographic support, the signal can be processed to eliminate, at least partially, components due to the data ranges from it, and to only keep components due to the position marks. This operation is not essential, but constitutes an improvement especially when the recorded data are the data of an image or a photograph and when the position marks are uniform borders. The elimination of components due to the data ranges means eliminating signal variations due to the iconic content of the recorded image. It is based on the assumption that the image density variations are spread out over a number of ranges higher than the number of ranges taken along one side of a block. This assumption is very likely especially when a range is associated with each pixel of a recorded digital photograph.

The variations due to the image's iconic content are eliminated by high-pass filtering. A low-pass signal can also be produced at first, in the form of a sliding average of the values of the reading pixels. Then the low-pass signal is reshaped with the non-filtered signal to obtain a high-pass signal.

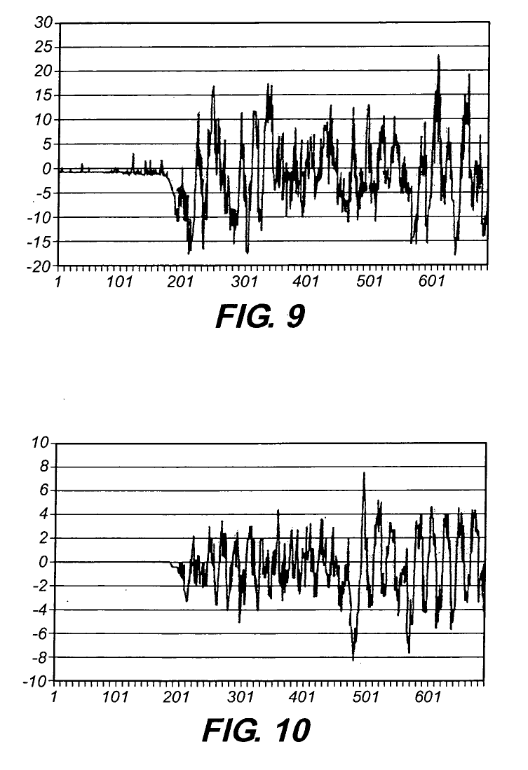

FIGS. 8, 9 and 10 show the filtered signals obtained from the reading signals of FIGS. 5, 6 and 7 respectively.

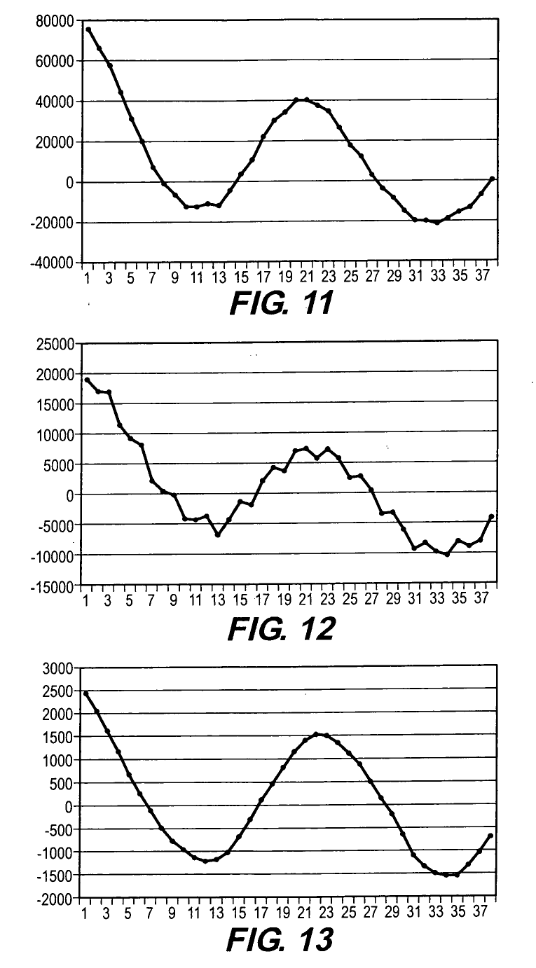

The next step consists in establishing the pseudo-period of the position marks. During this step, a signal, and preferably filtered signal, auto-correlation function is calculated. The auto-correlation functions are shown in FIGS. 11, 12 and 13. They correspond to the signals of FIGS. 8, 9 and 10. On the abscissa the graphs give a position expressed in the number of reading pixels. The ordinate gives a density level (transparency) not to scale.

It can be seen that the auto-correlation functions have a pseudo-period that is, in this case, approximately 22 reading pixels. The period is determined by measuring, for example, the distance between two parts of the curve at a local extremum. In the illustrated example, the dimension of the blocks is, thus, 22 pixels in the row direction.

It should be noted that the determined period does not necessarily correspond to a whole number of pixels. To facilitate the following calculations, it is possible to slightly modify the scanner reading pitch, if this option exists, to adjust the pseudo-period to a whole value.

The pseudo-period is determined more or less easily according to the color channel whose signal is used. This is because the borders have more or less significant contrast according to the colors selected. For example, a red border will have a very low contrast on the “red” channel and a high contrast on the “green” or “blue” channels. However, it is not necessary to use the reading signals of every color. The signal of a single color, or a simple density signal in gray levels can be enough.

It is worth stressing that, for reasons of simplification, the graphs only show the reading signal of a single row. Based on the signals of all the rows, it is possible to establish a two-dimensional pseudo-period in the plane of the photographic support. In other words, it is possible to establish a pseudo-period of the reading rows and a columns pseudo-period.

Then a kernel is build corresponding to the determined spatial pseudo-periods. The kernel is a mathematical operator that corresponds to a reading pixel matrix representing the pattern whose spatial period equals that of the position marks, in this case the borders.

For example, the kernel has the following form:

| | | | | | | | |
|---|---|---|---|---|---|---|---|
| 0 | 0 | 1 | 0 | 0 | 1 | 0 | 0 |
| 0 | 0 | 1 | 0 | 0 | 1 | 0 | 0 |
| 1 | 1 | 1 | 1 | 1 | 1 | 1 | 1 |
| 0 | 0 | 1 | 0 | 0 | 1 | 0 | 0 |
| 0 | 0 | 1 | 0 | 0 | 1 | 0 | 0 |
| 0 | 0 | 1 | 0 | 0 | 1 | 0 | 0 |
| 1 | 1 | 1 | 1 | 1 | 1 | 1 | 1 |
| 0 | 0 | 1 | 0 | 0 | 1 | 0 | 0 |
| 0 | 0 | 1 | 0 | 0 | 1 | 0 | 0 |

This is a kernel representative of a pseudo-period of three reading pixels in the reading row direction and approximately four pixels in the reading column direction. The kernel shown above does not correspond to the pseudo-period of the previous figures, for reasons of simplification.

The kernel is used to determine locally the location of the position marks in the image. This operation can simply comprise an intercorrelation calculation between the data of the non-filtered digital image and the kernel. More precisely, the location of the position marks corresponds to the intercorrelation function extrema. According to the use of positive or negative logic, this concerns the function maxima or minima. They can be determined by calculation.

At this stage of the method the exact position of the writing ranges is still not know, but the position of each block is known, given that the position marks are associated with the blocks respectively.

Knowledge of the block locations indicates the distortion of the image support. This distortion is continuous and low frequency compared with the block spatial frequency. Any positioning error of a block can be detected and corrected by suitable low pass filtering.

On the other hand, information on the range distribution pattern, combined with that of the block location, enables the writing range position to be deduced immediately. It is enough therefore to keep the value of the pixels corresponding to these positions, expressed in the number of reading pixels.

For example, if the distribution of ranges in a block corresponds to a 3×2 square grid, the selected data are those corresponding to this grid, and preferably those corresponding to the center of the squares when the reading scanner's resolution enables this. This enables errors due to a possible uniformity defect of the writing ranges to be prevented.

When the resolution of the reading equipment is close to that of the support, i.e. if the area of a reading zone is close to the area of a writing range, a relative movement between the scanner's reading head used to read the support or a movement of a reading spot can be made in order to refine the match between the reading zones and writing ranges.

The distribution of the writing ranges in the blocks can be visually determined data, possibly using a microscope. It can also be data made legibly on the support, in text or symbol form.

The selection of image data coinciding with the writing ranges can also take place according to a periodic phasing signal supplied by an autonomous reading of the support aiming at detecting the position marks. When the support has position marks with magnetic particles, the reading can make use of the Kerr effect.

Kerr effect reading, which is added to that of the writing ranges, can be also performed to simply determine the pseudo-period of the marks. In this case, the method continues in the manner already described.

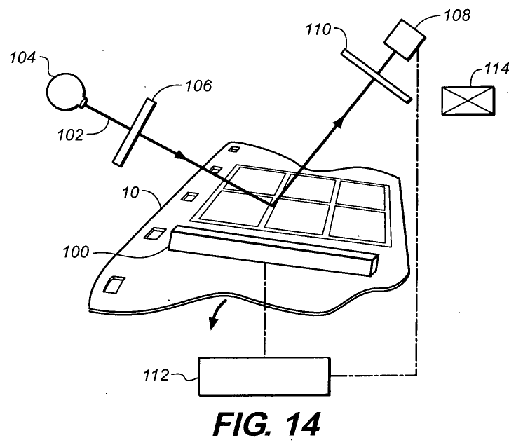

A Kerr effect reading is illustrated by FIG. 14.

The photographic support 10, in this case a film, is moved in front of the on-line sensor 100 of a scanner. At the same time, the film is scanned by a laser beam 102 emitted by a laser source 104. The beam crosses a polarizer 106 before reaching the support 10 so as to have a first polarization. Part of the beam, re-emitted from the support 10, is collected by a photoelectric sensor 108 having crossed an analyzer 110. The photoelectric sensor 108 measures the intensity of the beam re-emitted after crossing the analyzer.

When the beam 102 scans a zone of the support 10 not having position marks, its polarization is not affected. The photoelectric sensor then measures a first intensity value. This depends, among others, on the relative angular position of the polarizer and the analyzer, in relation to the direction of polarization.

On the other hand, when the beam 102 scans a zone of the support where there is a magnetic field, its polarization undergoes a rotation. This takes place especially when the beam reaches a position mark bearing magnetized magnetic particles. Because of the rotation of polarization, the luminous intensity observed by the photoelectric sensor 108 is modified. For example, if the polarizer and the analyzer are angularly aligned, the beam undergoes partial or total extinction on crossing the analyzer when it has undergone a rotation of its polarization. Thus a periodic reduction or increase of the signal supplied by the photoelectric sensor converts the regular presence of marks on the support into movement.

The signal of the photoelectric sensor can be supplied to a controller 112 capable of using this signal to synchronize the signal supplied by the sensor 100 on the writing ranges found between the position marks. The signal can be also used to establish the spatial period or pseudo-period of the position marks by taking into account the speed of advance of the support 10.

A magnet 114 is planned upstream of the zone scanned by the beam 102 in order to magnetize, or strengthen the magnetization of the magnetic particles of the position marks. The magnet is not necessary if the particles are already magnetized.

In the particular case of using fluorescent materials for the marks, a double reading can be performed. A first reading is performed in the presence of an additional UV light source. A second reading is performed normally. The exact location of the position marks is determined by the difference between the reading data. A possible adaptation of the blocking of the sensor used for the reading, or the flying spot can be made in order to adjust the period of the marks to a whole value expressed as a number of pixels.

The invention has been described in detail with particular reference to certain preferred embodiments thereof, but it will be understood that variations and modifications can be effected within the scope of the invention.

1. A method of recording of digital data on a photographic support, comprising:
converting data into at least one of color and density values; and
writing, for each data item, at least one writing range including at least one color and density corresponding to the data, wherein the writing ranges are arranged in a plurality of uniform blocks of writing ranges covering a writing zone of the photographic support, the uniform blocks each being formed of at least one writing range and being associated with at least one position mark fixed to the support respectively.

2. The method according to claim 1, wherein the at least one position mark is an optically legible mark.

3. The method according to claim 1, wherein the at least one position mark comprises a border of at least one of substantially uniform color and substantially uniform density adjacent to the block, separating at least one side of the block and at least one neighboring block.

4. The method according to claim 1, wherein the at least one position mark comprises at least one of magnetic and fluorescent particles arranged on a surface of the photographic support.

5. The method according to claim 1, wherein the at least one position mark comprises at least one of magnetic and fluorescent particles arranged in the photographic support.

6. The method according to claim 1, wherein the blocks are rectangular and comprise a border on two adjacent sides.

7. The method according to claim 1, wherein the photographic support is photosensitive and in which at least one among the writing ranges and the position marks is formed by exposure of the support.

8. The method according to claim 1, wherein the at least one among the writing ranges and the position marks is formed using inkjet.

9. The method according to claim 1, wherein the at least one position mark includes non-exposed zones of a photosensitive support.

10. The method according to claim 1, wherein the at least one position mark includes non-sensitive zones of a photosensitive support.

11. The method according to claim 1, wherein the writing ranges are written in an aligned manner on a photographic support, having previously-formed position marks.

12. The method according to claim 1, wherein the writing ranges are written and the position marks formed concomitantly.

13. The method according to claim 1, wherein the data includes data of at least one image, and the blocks and writing ranges are arranged so as to reproduce the image's iconic content.

14. A photographic support comprising:
a plurality of writing ranges, the writing ranges being arranged in blocks uniformly covering a writing surface and the blocks being associated with position marks.

15. The photographic support according to claim 14, wherein the position marks comprise borders of at least one of substantially uniform color and substantially uniform density separating the blocks.

16. The photographic support according to claim 14, wherein the position marks comprise magnetic particles.

17. A method of reading a support according to claim 14, the method comprising:
reading the photographic support to supply a digital image and a distribution pattern of the writing ranges in each block; and
selecting data corresponding to a location of the writing ranges of each block.

18. The method according to claim 17, wherein selecting data corresponding to the location of the writing ranges comprises:
establishing a pseudo-period of repetition of the position marks;
generating a kernel corresponding to the pseudo-period;
calculating a function of inter-correlation of the digital image and the kernel to determine an extrema location of the inter-correlation function; and
selecting data of the digital image corresponding to the extrema and coinciding with the distribution pattern of the writing ranges.

19. The method according to claim 18, wherein establishing the pseudo-period of repetition of the position marks takes place by calculating an auto-correlation function of the digital image, and searching for a pseudo-period of the auto-correlation function.

20. The method according to claim 18, wherein establishing the pseudo-period of repetition of the position marks takes place by reading the marks optically.

21. The method according to claim 20, wherein reading the marks is by Kerr effect.

22. The method according to claim 18 further comprising:
high-pass filtering of the digital image before calculating the inter-correlation function.

23. The method according to claim 17, wherein selecting the data including selecting image data using a periodic signal supplied by a Kerr effect reading of the support.
